(19) United States
(12) Patent Application Publication
(10) Pub. No.: US 2024/0204189 A1
(43) Pub. Date: Jun. 20, 2024

(54) NEGATIVE ELECTRODE CONTAINING TWO TYPES OF SILICON-BASED MATERIALS AND LITHIUM SECONDARY BATTERY INCLUDING THE SAME

(71) Applicant: KOREA ELECTRONICS TECHNOLOGY INSTITUTE, Seongnam-si (KR)

(72) Inventors: Sang Gil WOO, Suwon-si (KR); Je Nam LEE, Seongnam-si (KR)

(21) Appl. No.: 18/498,522

(22) Filed: Oct. 31, 2023

(30) Foreign Application Priority Data
Dec. 20, 2022 (KR) 10-2022-0179204

(51) Int. Cl. H01M 4/583; H01M 4/38; H01M 10/052

(52) U.S. Cl. CPC H01M 4/583; H01M 4/386; H01M 10/052; H01M 2004/027

(57) ABSTRACT

A negative electrode is proposed. The negative electrode may contain two types of silicon-based materials to improve both energy density and lifespan characteristics, and can be used for a lithium secondary battery. The negative electrode may include a carbon-based material and two types of silicon-based materials with different physical properties, sizes, and shapes.

### CROSS REFERENCE TO RELATED APPLICATIONS

The present application claims priority to Korean Patent Application No. 10-2022-0179204 filed Dec. 20, 2022, the entire contents of which are incorporated herein for all purposes by this reference.

### BACKGROUND

### Technical Field

The present disclosure relates to a lithium secondary battery. Specifically, the present disclosure relates to a negative electrode containing two types of silicon-based materials to improve both energy density and lifespan characteristics, and to a lithium secondary battery including the same.

### Description of Related Technology

As for negative electrode active materials of lithium secondary batteries commercialized currently, technology is being developed to improve the energy density of the electrode by mainly using graphite and mixing a small amount of silicon-based compounds. However, such negative electrodes are currently reaching their limitations.

### SUMMARY

One aspect is a negative electrode containing two types of silicon-based materials to improve both energy density and lifespan characteristics, and also provides a lithium secondary battery including the same.

Another aspect is a negative electrode for a lithium secondary battery that includes a carbon-based material and two types of silicon-based materials with different physical properties, sizes, and shapes.

The two types of silicon-based materials may include a first silicon-based material which is in the form of at least one of particles, fibers, and flakes, and has a particle size of 100 to 500 nm; and a second silicon-based material which is spherical and has a particle size of 1 to 20 μm.

The first silicon-based material may include at least one of silicon, nano-silicon, and silicon dust.

A composition ratio of the first and second silicon-based materials may be 3:7 to 7:3.

The content of the first silicon-based material may be higher than content of the second silicon-based material.

A mixture density of the negative electrode may be 0.9 to 1.7 g/cm³.

Another aspect is a lithium secondary battery that includes a negative electrode that contains a carbon-based material and two types of silicon-based materials with different physical properties, sizes, and shapes.

According to the present disclosure, since two types of silicon-based materials with different physical properties, sizes, and shapes are mixed and used as a negative electrode active material while controlling the density of the mixture, it is possible to increase the filling degree of the active material in the electrode. This results in securing a highly electrically conductive network even with a small amount of conductive additive. Furthermore, an empty space inside the electrode can be stably secured to increase the impregnability and mobility of electrolyte and use it as a buffer space for repeated silicon volume changes during charging and discharging. As a result, it is possible to improve both energy density and lifespan characteristics at the same time.

In other words, by mixing two types of silicon-based materials with different physical properties, sizes, and shapes, it is possible to use a large amount of small particle size silicon, which has relatively high mechanical durability against volume changes, in the cathode. Accordingly, the capacity of the negative electrode can be increased and the energy density of the lithium secondary battery can be maximized.

Moreover, by mixing two types of silicon-based materials with different physical properties, sizes, and shapes, it is possible to increase the filling degree of materials in the electrode and thereby increase the mixture density. As a result, the utilization of silicon can be improved by enhancing the electrical conductivity of the negative electrode.

In addition, by mixing two types of silicon-based materials with different physical properties, sizes, and shapes, it is possible to form a structure capable of efficiently arranging a buffer space for volume changes of the silicon-based materials and facilitating the impregnation and movement of the electrolyte. As a result, the lifespan characteristics of the lithium secondary battery can be improved.

### BRIEF DESCRIPTION OF THE DRAWINGS

FIG. 1 is a graph showing the tap density according to the mixing ratio of two types of silicon-based materials.

FIG. 2 is a graph showing the initial capacity for each mixing ratio of a negative electrode to which two types of silicon-based materials are applied.

FIG. 3 is a graph showing the room temperature lifespan characteristics for each mixing ratio of a negative electrode to which two types of silicon-based materials are applied.

FIG. 4 is a graph showing the electrical conductivity for each mixture density of a negative electrode to which two types of silicon-based materials are applied at a mixing ratio of 5:5.

FIG. 5 is a graph showing the initial capacity for each mixture density of a negative electrode to which two types of silicon-based materials are applied at a 5:5 mixing ratio.

FIG. 6 is a graph showing the room temperature lifespan characteristics for each mixture density of a negative electrode to which two types of silicon-based materials are applied at a mixing ratio of 5:5.

### DETAILED DESCRIPTION

Graphite, which accounts for 90% or more of the negative electrode active material, currently realizes almost all of its theoretical capacity. Thus, in order to increase energy density, technology development is underway to increase the content in the electrode. Increasing the graphite content in the electrode needs to increase the electrode thickness. However, when the electrode thickness is large, it is difficult to ensure smooth and homogeneous movement of electrons for electrochemical reactions and lithium ions in the electrolyte solution. Therefore, resistance formation in the negative electrode becomes larger, and thus the lifespan deterioration gradually increases.

Due to this problem, it is difficult to increase the energy density of a lithium secondary battery with graphite alone, so technology development is being conducted to mix silicon having a relatively large capacity per mass. However, since silicon-based materials have very low electrical conductivity and thus need to further use a large amount of conductive additive and binder, the effect of increasing energy density becomes offset. That is, because silicon has very low electrical conductivity, it requires a large amount of conductive additive unlike graphite which is a carbon-based material. In addition, a relatively large amount of binder is required to make electrodes using the current process. Ultimately, because the silicon content in the electrode is reduced, a decrease in energy density cannot be avoided.

Moreover, because silicon-based materials undergo a large change in volume when reacting with lithium, as their lifespan progresses, electrical contact cannot continue to be sufficiently established, leading to a rapid decrease in capacity. In other words, when silicon is used as the negative electrode of a lithium secondary battery, it repeatedly forms an alloy with lithium during the charging and discharging process. At this time, the silicon undergoes a volume change of 400% or more, which causes cracks and pulverization of the silicon during its life within the electrode. This accelerates performance deterioration due to lack of electrical conductivity caused by exposure of a new surface or weakening of the bonding force with the current collector. Therefore, currently, silicon-based materials are used as less than 10% of the active material in the negative electrode.

As a result, maximization of the silicon content in the negative electrode is needed to improve the energy density of the lithium secondary battery, but it is difficult to maximize performance with current technology due to a series of problems with silicon.

In order to overcome such problems with silicon, there are attempts to reduce negative effects due to mechanical deformation by nanoizing the particle size. However, the nanoization of silicon particles results in an increase in the specific surface area of the active material, requires more conductive additives and binders, and also makes it difficult to achieve a high electrode mixture density, again causing deterioration in the performance of the negative electrode.

In addition, many technologies have been reported to control or alleviate the volume change of silicon by manufacturing it with compounds such as carbon or oxygen or alloys with other metals. In this case, because only a portion of the capacity of silicon is used, there is a limit to maximizing energy density.

Now, embodiments of the present disclosure will be described in detail with reference to the accompanying drawings.

However, in the following description and the accompanying drawings, well known techniques may not be described or illustrated in detail to avoid obscuring the subject matter of the present disclosure. Through the drawings, the same or similar reference numerals denote corresponding features consistently.

The terms and words used in the following description, drawings and claims are not limited to the bibliographical meanings thereof and are merely used by the inventor to enable a clear and consistent understanding of the disclosure. Thus, it will be apparent to those skilled in the art that the following description about various embodiments of the present disclosure is provided for illustration purpose only and not for the purpose of limiting the disclosure as defined by the appended claims and their equivalents.

A negative electrode for a lithium secondary battery according to the present disclosure includes a carbon-based material and a silicon-based material as a negative electrode active material. In addition, the negative electrode according to the present disclosure may further include a conductive additive and a binder.

The carbon-based material may use graphite.

The silicon-based material may use two types of silicon-based materials with different physical properties, sizes, and shapes. The two types of silicon-based materials include a first silicon-based material and a second silicon-based material.

The first silicon-based material is in the form of at least one of particles, fibers, and flakes, and has a particle size of 100 to 500 nm. The first silicon-based material includes at least one of silicon, nano-silicon, and silicon dust.

The second silicon-based material is spherical and has a particle size of 1 to 20 μm. The second silicon-based material includes at least one of silicon oxide, silicon alloy, and silicon carbon compound. In the silicon oxide (SiOₓ), ‘x’ may have a composition of less than 3. In the silicon alloy, metal may include at least one of Fe, Mg, Sn, Al, Pb, P, and Sb.

The composition ratio of the first and second silicon-based materials may be 3:7 to 7:3, considering the filling degree and energy density of the entire electrode. If the composition of the first silicone-based material exceeds 70% by weight compared to the second silicone-based material, the tap density decreases because the proportion of the first silicone-based material with a small particle size is high, but a problem may occur due to an increase in the specific surface area. Conversely, if the composition of the first silicon-based material is less than 30% by weight compared to the second silicon-based material, the effect of increasing energy density by increased tap density may be minimal. Therefore, by maintaining the composition ratio of the first and second silicon-based materials between 3:7 and 7:3, a similar tap density can be obtained. When the ratio of the first silicon-based material is increased within the above composition ratio, the energy density can be improved while the filling degree of the entire electrode is maintained similar. Therefore, within the above composition ratio, it is advantageous in terms of energy density to maintain the content of the first silicon-based material higher than the content of the second silicon-based material.

In addition, the mixture density of the negative electrode is preferably 0.9 to 1.7 g/cm³. Of course, the higher the mixture density of the negative electrode, the higher the energy density. However, considering the lifespan characteristics of lithium secondary battery, if the mixture density is less than 0.9 g/cm³ or exceeds 1.7 g/cm³, the lifespan characteristics deteriorate.

The conductive additive serves to increase the overall conductivity of the negative electrode active material and improve the output characteristics of the battery. Any conductive material can be used without particular restrictions as long as it has excellent electrical conductivity and does not cause side reactions in the internal environment of the lithium secondary battery. Preferably, the conductive additive uses a highly conductive carbon-based material such as graphite or conductive carbon. Of course, highly conductive polymer can also be used as the conductive additive. Specifically, graphite is not limited to natural graphite or artificial graphite. Conductive carbon is preferably a highly conductive carbon-based material such as a material selected from the group consisting of carbon black, acetylene black, Ketjen black, channel black, furnace black, lamp black, thermal black, and a material whose crystal structure contains graphene or graphite, or a mixture of such materials. Additionally, as a precursor for the conductive additive, any material that is converted into a conductive material during firing at a relatively low temperature in an atmosphere containing oxygen, for example, an air atmosphere, can be used without particular restrictions. A method of including the conductive additive is also not particularly limited, and conventional methods known in the art, such as coating the negative electrode active material, can be adopted.

The binder can be used without restrictions as long as it is a material used for the electrode of the lithium secondary battery. For example, the binder may use polyvinylidene fluoride (PVDF), polyacrylonitrile, polymethyl methacrylate, vinylidene fluoride/hexafluoropropylene copolymer, etc., alone or in any mixture thereof.

A solvent is used in the manufacturing process of the negative electrode. The solvent can use, but is not limited to, at least one of distilled water, ethylene glycol, diethylene glycol, triethylene glycol, dimethyl sulfoxide, dimethyl formide, ethanol, propanol, butanol, pentanol, hexanol, N-methyl-2-pyrrolidone, and acetone.

The lithium secondary battery to which the above-described negative electrode according to the present disclosure is applied may further include a positive electrode, a separator, and an electrolyte. The positive electrode, the separator, and the electrolyte applied to the lithium secondary battery according to the present disclosure may be made of general materials well known in the art, so detailed description thereof will be omitted.

### Embodiments and Comparative Examples

In order to confirm the physical and electrochemical properties of the negative electrode according to the present disclosure, a negative electrode and a lithium secondary battery were manufactured according to the following Embodiments and Comparative Examples.

### Mix of Two Types of Silicone-Based Materials

First, in order to develop technology for improving optimal negative electrode properties by mixing two types of silicon-based materials with different composition, physical properties, and shapes, silicon dust and silicon-iron alloy were used as the first and second silicon-based materials, respectively. Silicon dust used as the first silicon-based material has a relatively high capacity per mass and a relatively small particle size (about 150 nm), whereas silicon-iron alloy (Si—Fe alloy) used as the second silicon-based material has a relatively low capacity per mass and a relatively large particle size (less than 3 μm) and has stable life characteristics.

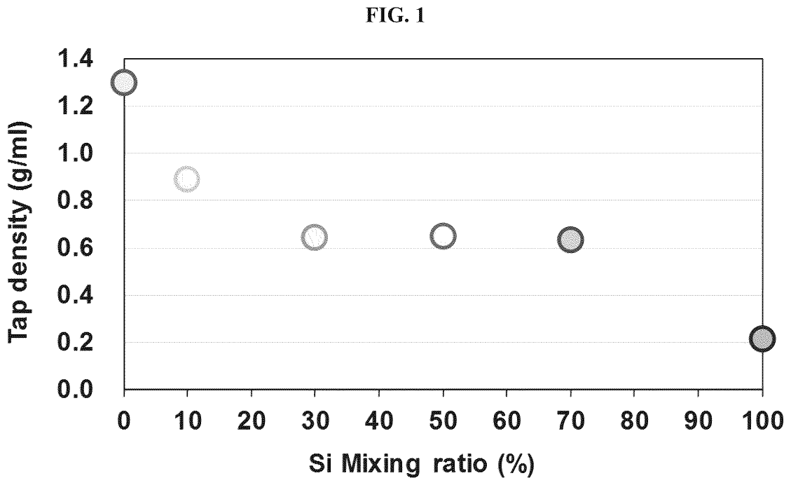

In order to check whether the electrode filling degree is improved by mixing two types of silicon-based materials, the total amount was set to achieve the same capacity per unit area in Embodiments and Comparative Examples. Thereafter, silicon-iron alloy (Si—Fe alloy; SiFe) and silicon dust (Si) were mixed at 10:0, 9:1, 7:3, 5:5, 3:7, and 0:10, respectively, and then the tap densities were measured. The measurement results of tap density are shown in FIG. 1. Here, FIG. 1 is a graph showing the tap density according to the mixing ratio of two types of silicon-based materials.

The SiFe:Fe mixing ratios of 10:0, 9:1, 7:3, 5:5, 3:7, and 0:10 were used in Comparative Example 1-1, Embodiment 1-1, Embodiment 1-2, Embodiment 1-3, Embodiment 1-4, and Comparative Example 1-2, respectively.

Referring to FIG. 1, due to a difference in particle size between the two materials, the highest tap density can be seen in Comparative Example 1-1 (denoted by 0 on the x-axis) using only silicon-iron alloy, and the lowest tap density can be seen in Comparative Example 1-2 (denoted by 100 on the x-axis) using only silicon dust.

However, in Embodiments 1-2 to 1-4 where SiFe:Si=7:3, 5:5, and 3:7, respectively, similar tap densities can be seen. According to Embodiments 1-2 to 1-4, it means that even if the content of small-sized silicon dust with a large specific surface area is increased, the filling degree of the entire electrode is implemented same by the difference in particle size and the combination, and it is possible to implement a large negative electrode capacity at a high filling degree.

In order to compare and analyze differences in electrochemical properties according to combinations of two types of silicon-based materials with different composition, physical properties, and shapes, the silicone-based materials according to Comparative Example 1-1, Embodiment 1-1, Embodiment 1-2, Embodiment 1-3, Embodiment 1-4, and Comparative Example 1-2 were used as a negative electrode active material.

A slurry was prepared by dissolving the negative electrode active material, the conductive additive, and the binder in water at weight ratios of 80 wt %, 10 wt %, and 10 wt %, respectively. Then the slurry was applied to a copper foil with a thickness of 10 μm, dried, compacted with a press, and dried in vacuum at 80° C. for 12 hours to manufacture a disk-shaped electrode (negative electrode) with a diameter of 12 mm. All six types of electrodes according to Comparative Examples and Embodiments were manufactured with the same capacity per unit area (3 mAh/cm²) to exclude other influences other than the mixing ratio.

Lithium metal foil punched to a diameter of 14 mm was used as the counter electrode and reference electrode, and PE film was used as the separator. In addition, for the electrolyte, 1 wt % of VC and 12 wt % of FEC were used as additives in a mixed solution of 1M LiPF₆ and EC:EMC:DMC=2:4:4 (v/v/v).

After the electrolyte was impregnated into the separator, the separator was sandwiched between the working electrode and the counter electrode. Then a lithium secondary battery was manufactured using a case (model name CR2032, SUS).

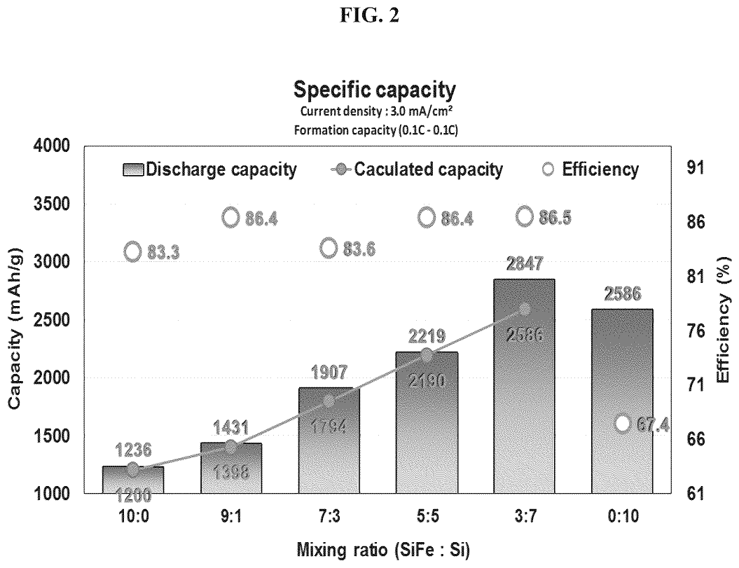

For six types of lithium secondary batteries according to Comparative Examples and Embodiments, charge and discharge were performed twice at 0.1 C in the range of 0.01 to 2.0 V (vs. Li+/Li) under 25° C. conditions, and then the initial charge/discharge capacity was measured in six types of electrodes. The measurement results are shown in FIG. 2. Here, FIG. 2 is a graph showing the initial capacity for each mixing ratio of a negative electrode to which two types of silicon-based materials are applied.

Referring to FIG. 2, it can be seen that in case of mixing with silicon-iron alloy as in Embodiments 1-1 to 1-4 than in case of using only silicon dust as in Comparative Example 1-2, the initial capacity appears higher than the expected capacity. This is because by mixing two types of silicon-based materials of different sizes and shapes, the material filling degree in the electrode was increased, and thus the reactivity of silicon was increased by an improved electrical conduction network.

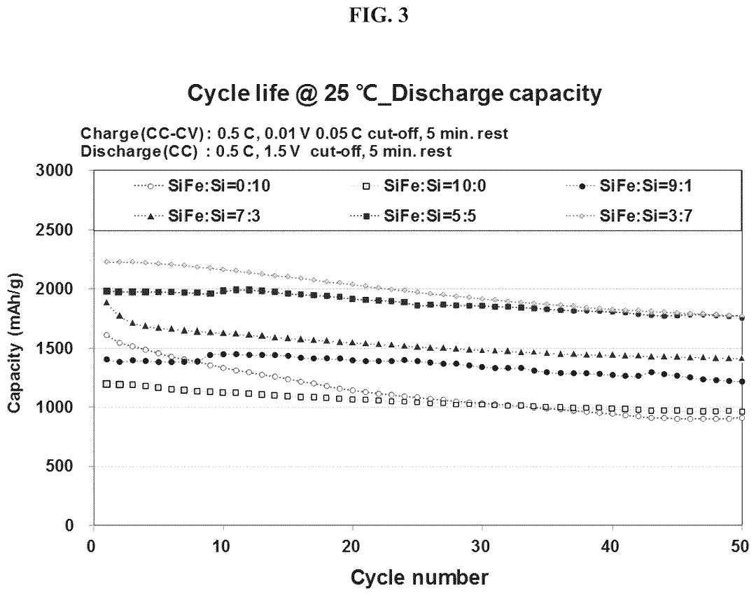

FIG. 3 is a graph showing the room temperature lifespan characteristics for each mixing ratio of a negative electrode to which two types of silicon-based materials are applied.

Referring to FIG. 3, in order to compare the room temperature lifespan characteristics of six types of negative electrodes, charging with a constant current-constant voltage linkage of 0.5 C and discharging with a constant current of 0.5 C were repeated 50 times in the range of 0.1 to 2.0 V (vs. Li+/Li) at 25° C.

It can be seen that the lifespan characteristics were significantly improved in case of using a mixture of silicon dust and silicon-iron alloy as in Embodiments 1-1 to 1-4 than in case of using only silicon dust as in Comparative Example 1-2. In particular, compared to Comparative Example 1-2, improved lifespan characteristics can be confirmed in Embodiments 1-2 to 1-4.

Summarizing these results, it was confirmed that by using two types of silicon-based materials with different sizes and shapes together, the improvement in filling degree between the two types of silicon-based materials can simultaneously improve the energy density and lifespan characteristics of a lithium secondary battery.

### Mixture Density

Next, in order to check whether the performance of a negative electrode is improved through the mixture density control technology for the negative electrode obtained by mixing two types of silicon-based materials, three types of electrodes were manufactured using a mixture of silicon dust and silicon-iron alloy at a 5:5 ratio as an active material through the same composition, design factors, and manufacturing process as Embodiment 1-3 except for the mixture density. The electrode with a mixture density of 1.1 g/cm³ was set as Embodiment 2, and the electrodes with mixture densities of 0.9 and 1.3 g/cm³ were set as Comparative Examples 2-1 and 2-2, respectively.

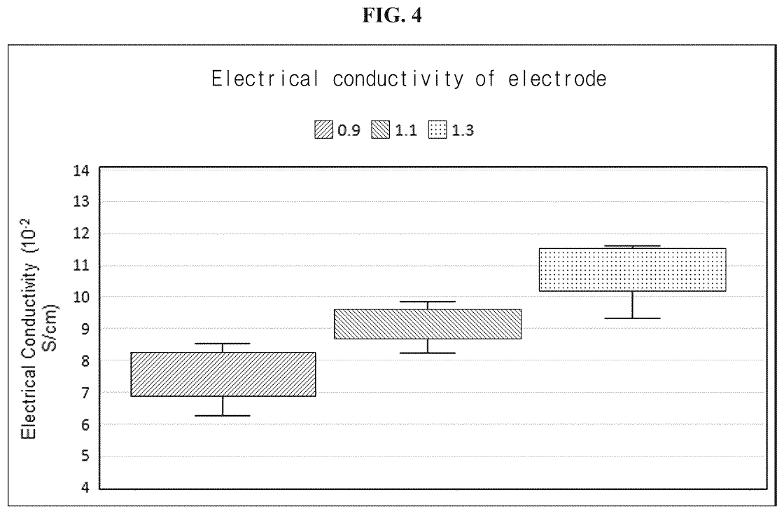

The results of measuring the electrical conductivity of three types of electrodes (Embodiment 2, Comparative Example 2-1, and Comparative Example 2-2) using the 4-point measurement method are shown in FIG. 4. Here, FIG. 4 is a graph showing the electrical conductivity for each mixture density of a negative electrode to which two types of silicon-based materials are applied at a mixing ratio of 5:5.

Referring to FIG. 4, it can be seen that as the mixture density increases, the electrical conductivity increases due to an increase in the contact area with the conductive additive inside the electrode. That is, the mixture density increases in the order of Comparative Example 2-1, Embodiment 2, and Comparative Example 2-2, and the electrical conductivity increases in the same order as the mixture density.

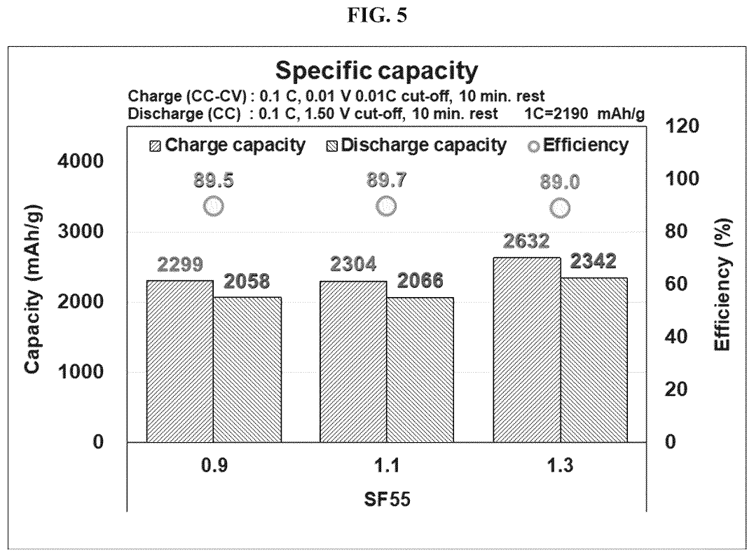

FIG. 5 is a graph showing the initial capacity for each mixture density of a negative electrode to which two types of silicon-based materials are applied at a 5:5 mixing ratio.

Referring to FIG. 5, as a result of performing charging and discharging with three types of electrodes (Embodiment 2, Comparative Example 2-1, and Comparative Example 2-2) at 0.1 C in the range of 0.01 to 2.0 V (vs. Li+/Li) under 25° C. conditions, it was confirmed that as the mixture density increases, the implemented capacity also increases. This is a result consistent with the tendency of electrical conductivity in FIG. 4, and it can be seen that the improved electrical conductivity caused an increase in the reactivity of silicon.

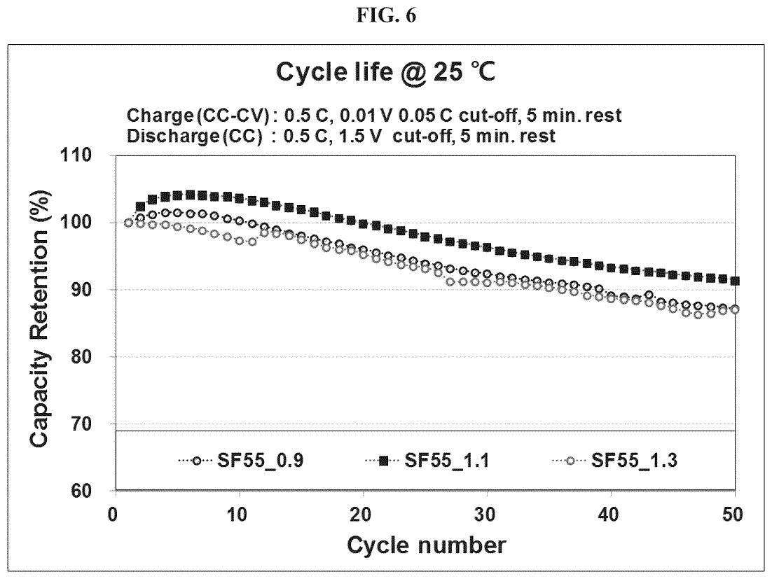

FIG. 6 is a graph showing the room temperature lifespan characteristics for each mixture density of a negative electrode to which two types of silicon-based materials are applied at a mixing ratio of 5:5.

Referring to FIG. 6, for the three types of electrodes with different mixture densities (Embodiment 2, Comparative Example 2-1, and Comparative Example 2-2), charging with a constant current-constant voltage linkage of 0.5 C and discharging with a constant current of 0.5 C were repeated 50 times in the range of 0.1 to 2.0 V (vs. Li+/Li) at 25° C. to compare lifespan characteristics.

In case of the lifespan characteristics, results different from those of the electrical conductivity in FIG. 3 and the initial capacity in FIG. 4 were confirmed. That is, it can be seen that the electrode according to Embodiment 2 implemented with a mixture density of 1.1 g/cm³ exhibited the best lifespan characteristics, and the electrodes according to Comparative Examples 2-1 and 2-2 respectively implemented with mixture densities of 0.9 and 1.3 g/cm³ exhibited similar lifespan characteristics. This shows that in electrode using two types of silicon-based materials, it is possible to improve the lifespan characteristics by changing the internal pore structure formed through mixture density control.

Therefore, by controlling the mixture density while using two types of silicon-based materials, both capacity and lifespan characteristics can be improved in conjunction with the electrical conductivity of the electrode.

While the present disclosure has been particularly shown and described with reference to an exemplary embodiment thereof, it will be understood by those skilled in the art that various changes in form and details may be made therein without departing from the scope of the present disclosure as defined by the appended claims.

What is claimed is:

1. A negative electrode for a lithium secondary battery, comprising:
a carbon-based material; and
two types of silicon-based materials with different physical properties, sizes, and shapes.

2. The negative electrode of claim 1, wherein the two types of silicon-based materials include:
a first silicon-based material in the form of at least one of particles, fibers, and flakes, and having a particle size of 100 nm to 500 nm; and
a second silicon-based material being spherical and having a particle size of 1 μm to 20 μm.

3. The negative electrode of claim 2, wherein the first silicon-based material includes at least one of silicon, nano-silicon, or silicon dust.

4. The negative electrode of claim 2, wherein a composition ratio of the first and second silicon-based materials is 3:7 to 7:3.

5. The negative electrode of claim 4, wherein a content of the first silicon-based material is higher than a content of the second silicon-based material.

6. The negative electrode of claim 5, wherein a mixture density of the negative electrode is 0.9 g/cm³ to 1.7 g/cm³.

7. A lithium secondary battery comprising:
a negative electrode including:
a carbon-based material; and
two types of silicon-based materials with different physical properties, sizes, and shapes.
